(19) United States
(12) Patent Application Publication
(10) Pub. No.: US 2005/0165855 A1
(43) Pub. Date: Jul. 28, 2005

(54) System and method for updating a design library

(76) Inventors: David Marshall, Ft. Collins, CO (US); Karl Bois, Ft. Collins, CO (US); Shad Shepston, Thornton, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/765,550

(22) Filed: Jan. 27, 2004

(51) Int. Cl. G06F 12/00

(52) U.S. Cl. 707/200

(57) ABSTRACT

A system and method for updating a library in a design database environment operable to be accessed by at least one design user. In one embodiment, a first engine associates an update file with appropriate design objects to generate an uncompiled update file in a trusted space environment. A second engine associated with the trusted space environment compiles the uncompiled update file into a compiled update file. A third engine transfers the compiled update file from the trusted space environment into the library in the design database environment.

### BACKGROUND

To reduce costs, circuit designers have developed design libraries which contain numerous standard design objects grouped by specific function, along with known electrical operating characteristics and parametric values including, for example, resistance and capacitance. Standard cell libraries are illustrative of design libraries that contain commonly used medium-scale integration (MSI) structures such as decoders, registers, and counters and commonly used large-scale integration (LSI) structures such as memories, programmable logic arrays, and microprocessors. The circuit designer utilizes the standard cells and custom cells to design and optimize the layout of circuit by, for example, reducing propagation delays and minimizing the size of the chip to increase the number of chips which can be fabricated on a single wafer.

The organizational and usage structure of design libraries is not without limitations, however. In particular, the requirements of librarians, i.e., design users performing updates on the library, and other users requiring access for design implementation are usually incompatible, thereby resulting in an unwieldy and inefficient database management system. Librarians require the library to be on an “unstable” platform to load updates. Design end-users, however, require constant access to the library on a “stable” platform in order to design a circuit, due to the inherent time constraints on a circuit design project. Typically, librarians require many hours of “downtime” to completely load and compile the library updates. Further, the amount of downtime may increase if the library updates fail to compile or, once compiled, crash the computer system containing the libraries.

### SUMMARY

A system and method are disclosed that provide for updating a library in a design database environment operable to be accessed by at least one design user. In one embodiment, a first engine associates an update file with appropriate design objects to generate an uncompiled update file in a trusted space environment. A second engine associated with the trusted space environment compiles the uncompiled update file into a compiled update file. A third engine transfers the compiled update file from the trusted space environment into the library in the design database environment.

### BRIEF DESCRIPTION OF THE DRAWINGS

FIG. 1 depicts a computer platform that supports a system for updating a library in a design database environment provided therein;

FIG. 2A depicts a hierarchical representation of one embodiment of a library associated with the computer platform;

FIG. 2B depicts a hierarchical representation of one embodiment of a synthesis interface associated with the computer platform; 1

FIG. 3 depicts a block diagram of one embodiment of a system for updating a library in a design database environment; and

FIG. 4 depicts a flow chart of one embodiment of a method for updating a library in a design database environment.

### DETAILED DESCRIPTION OF THE DRAWINGS

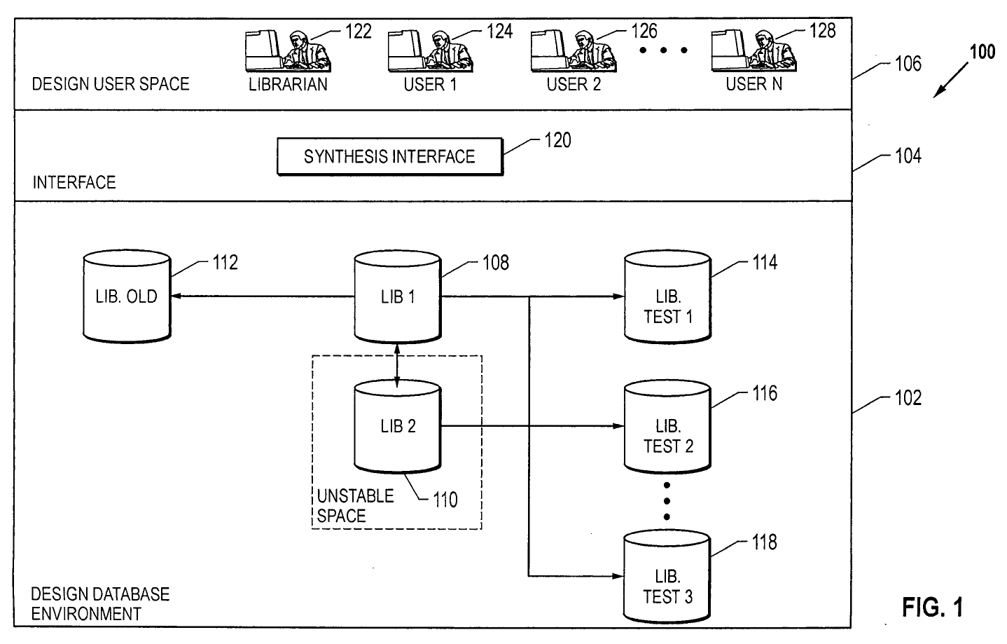

In the drawings, like or similar elements are designated with identical reference numerals throughout the several views thereof, and the various elements depicted are not necessarily drawn to scale. Referring now to FIG. 1, therein is depicted an embodiment of a computer platform 100 that supports a system for updating a library in a design database environment 102. As used herein, a “design database environment” is a computer-implemented construct for supporting one or more databases populated with IC design data including, e.g., behavioral and functional data, geometry data, connectivity information, et cetera. An interface 104 facilitates file updates from design user space 106 that supports one or more user interfaces to the design database environment 102 by providing a trusted space in which the file updates may be built. The design database environment 102 includes two instances of a primary library, i.e., library 108 which is designated LIB 1 and library 110 which is designated LIB 2. The library 108 provides users a stable library that permits the creation of derivative libraries to serve as archives and testing platforms. In the illustrated embodiment, the library 110 is a mirror of library 108 that is associated with an unstable space as opposed to the stable space with which library 108 is associated. In the context of the present patent application, “stable space” is defined as the portion of the design database environment that allows user access to databases for facilitating testing, IC design modeling, and other design activities. On the other hand, “unstable space” may be defined as the portion of the design database environment that is prone to frequent interfacing by the librarian for updating the database contents. Additional libraries in the design database environment include, for example, library 112, which is indicated by the LIB.OLD designation, that serves as an archival database, and libraries 114, 116, and 118, which are indicated by the LIB.TEST 1, LIB.TEST 2, and LIB.TEST 3 designations, respectively, that serve as testing libraries.

In one embodiment, the libraries 108-118 define a standard cell library that represents the development of the physical layout of a circuit design for all design circuit elements including leaf cells ranging from simple gates to latches and flip-flops. Further, the standard cell library may be a process-optimized cellular layout that takes advantage of special layers, local interconnects, and other features that may be unique to a given fabrication and design process. In this respect, the standard cell library described herein may be a generic library, a vendor process specific library, or a combination thereof. Each of the cells and sizes described in the library include the necessary port and connectivity information required for schematic, i.e., synthesis based, auto place-and-routing. Moreover, the standard cell library is fully interfaceable with a synthesis tool such that an adequate selection of cells and sizes of these cells may be made by manipulating the original netlists.

At the same level of hierarchy as the library structures 108-118, a structure having a suite of scripts that facilitate and govern the movement and validation of the data between the library structures 108-118 is also provided. A validation script is included for running a number of pertinent IC design tools on an individual cell, a list of cells, or a block. A global list of all cells used in the library infrastructure is also provided in the script structure. In one configuration, this global list may be comprised of artwork and schematic of every cell individually placed with space in between them. Other scripts such as update_lib and copy_lib script are operable to update and copy a LIB structure. Other structures at this level of hierarchy may comprise entities for performing maintenance-related functions. For example, a verilog_validation structure is operable to contain a Verilog behavioral description of all cells in the composite list of the cells. A valid_cell structure is operable as a script to validate the correct Verilog modeling of the cells therein. A check_in_out structure may be provided as a entity containing scripts that govern check_in, check_out and back_up functionality with respect to the various cells. Another structure, designated as xchecks, is operable to contain various lists and scripts pertaining to performing a final cross-checking of the library cells. Additionally, a lib.log file may be provided containing all known modifications.

The library organization described herein provides for effective management and use of the libraries 108-118 in the design database environment 102. As alluded to hereinabove, synthesis interface 120 of interface 104 facilitates file updates to any of the libraries 108-118 by a librarian 122 or User 1 124—User N 128 by providing a trusted space in which the file updates can be built before being transferred to the appropriate library or libraries. As used herein, “trusted space” and “trusted space environment” are deemed to be equivalent and generally mean a computer-supported memory space or a process therein that is relatively impervious to other processes and threads being executed on the computer platform. Further, the design database arrangement provides both a main primary library, i.e., the library 108, which is undisturbed and a mirror library, i.e., the library 110, which may be accessed for updating. With this arrangement, the librarian may install and build a release of updates in the library 110 without interfering with the users' utilization of libraries 108 and 114-118. Moreover, while users 124-128 interface with libraries 108 and 112-118 in the design database environment 102, the librarian 122 can utilize the synthesis interface 120 so that the librarian may develop synthesis updates away from the design database environment 102 on a stable platform.

Once the release of updates is installed in library 110, at a point which will cause minimal inconvenience to the users, the updates may be propagated to the other libraries with the utilization of the aforementioned suite of scripts. Moreover, the synthesis interface 120 allows for real time/minimum downtime synthesis updates and a central depository to archive these updates with respect to the various library versions 108-118. In one embodiment, to transfer the updates from library 110 to library 108, library 108 may be redefined such that library 108 resides in the unstable space and may be accessed by at least one librarian. Similarly, library 110 may be redefined such that library 110 resides in the stable space and may be accessed by at least one user. Alternatively, the permissions associated with library 108 and library 110 may be changed such that library 108 resides in the unstable space and library 110 resides in the stable space.

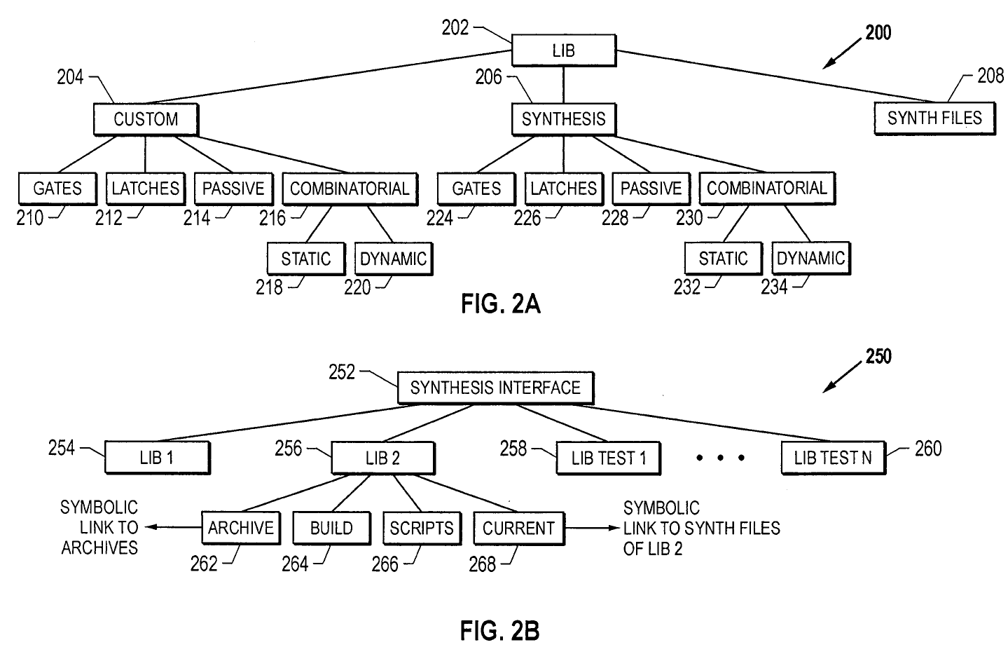

FIG. 2A depicts a hierarchical representation of one embodiment of a library 200 associated with the computer platform. In one implementation, the illustrated library 200 embodies an encapsulated database structure operable to be moved, manipulated, and renamed. In particular, this database structure may be any of the libraries 108-118 described previously in FIG. 1. A LIB file structure 202 serves as the root node for the hierarchical file representation of library 200 which accommodates both custom design elements 204 and synthesis design elements 206. Custom design elements represent design elements, such as blocks, requiring minimal changes or enhancements while synthesis design elements represent design elements requiring more extensive enhancements. As compared to custom design elements, synthesis design elements typically require more maintenance from librarians, but results in less work for the collective pool of design users.

Each of the custom and synthesis structures 204 and 206 contain the same design elements, e.g., cells. In particular, the custom file structure 204 includes file structures relating to gates 210, latches 212, passive design elements 214, and combinatorial design elements 216. The combinatorial design element file structure 216 may be further divided into a static file structure 218 and a dynamic file structure 220. Similarly, the synthesis file structure 206 includes gates 224, latches 226, passive design elements 228, and combinatorial design elements 230 that may be further divided into static 232 and dynamic 234 design elements. It should be appreciated that although the same cells may be provided in the custom and synthesis structures, custom and synthesis design elements have different maintenance requirements and the separation of the custom and synthesis cells provides more power to the librarian to meet the needs of users.

As will be discussed in greater detail hereinbelow, a synth files structure, which is disposed at the same hierarchical level as the custom structure 204 and synthesis file structure 206, contains files pertinent to synthesis and the updating of the files of the synthesis structure 206. In particular, the synth files structure 208 supports a link from a portion of the synthesis interface in order to effectuate the transfer of the update files from the design user space 106 to the design database environment 102. It should further be appreciated that the teachings disclosed herein are compatible with any standard cell format and are not limited to the hierarchical arrangements presented herein.

FIG. 2B depicts a hierarchical file representation of one embodiment of a synthesis interface 250 associated with the computer platform. The synthesis interface 250 facilitates the building of file updates in a trusted space and the selective transfer of the file updates to any of the libraries of the design database environment. In this respect, a root file structure, i.e., synthesis interface file structure 252, of the synthesis interface 250 includes a sub-hierarchical file structure for each of the libraries present in the design database environment. As illustrated, synthesis interface 252 includes a LIB 1 file structure 254, LIB 2 file structure 256, and testing library file structures, i.e., LIB Test 1 file structure 258 through LIB Test N file structure 260, that correspond to testing libraries. Each of these file structures 254-260 includes the same underlying file structures. For purposes of explanation, the infrastructure of the LIB 2 file structure 256 are depicted and explained in further detail. At the same level as libraries 254-260, a suite of scripts supports development in the archive file structure 262, build structure 264, script structure 266, and current structure 268. This suite of scripts may include the following file structures: core-files, flow.txt, cell_cur_leg.list, cell_cur_lib.list, and abutment. The core_files file structure contains central files to synthesis generation, such as technology and header files. Additionally, the core_files file structure may include test versions of these central files. The flow.txt file structure may contain the instructions for synthesis file generation in each of the libraries 108-118. The cell_cur_lef.list and cell_cur_lib.list file structures include a list of cells to be included in the synthesis portions of the libraries 108-118. The abutment file structure may be utilized to test the synthesis cells for placement and abutment.

With respect to the LIB 2 file structure, an archive file structure 262 provides a symbolic link to an archival database which may be used as a single storage area for all generated synthesis file packages and file updates relating to LIB 2. Accordingly, in operation, after a copy of the contents is built and transferred to the appropriate library in the design database environment, the archival file structure 262 transfers the contents to the archival database. A build structure 264 contains the scripts required to build the update files and the space for building the update files.

In one embodiment, the scripts include a lef_“process_id” script and a lib_“process_id” script used for synthesizing and processing the content of the aforementioned core_files file structure. Each synthesis cell also contains a script file structure 266 that includes, for example, files relating to synthesis operations such as defining physical structure and timing paths of the design objects.

Once all of the pertinent files are placed in the build directory and built, they can all be copied into a current structure 268, which as will be described in further detail hereinbelow, comprises a convenience link in the form of a symbolic link to the synth files structure of LIB 2. Hence, all of the data encapsulated by the script file structure 266 and the build structure 264 in the trusted space provided by the build structure 264 can be transferred to the synth files structure of LIB 2 substantially instantaneously, causing minimal downtime for users. Specifically, by building, i.e., compiling, testing, and related operations, the file updates prior to their transferring, not only can the file updates be substantially instantaneously transferred but any file corruptions that occur in the synthesis interface 252 are not propagated to the design database environment.

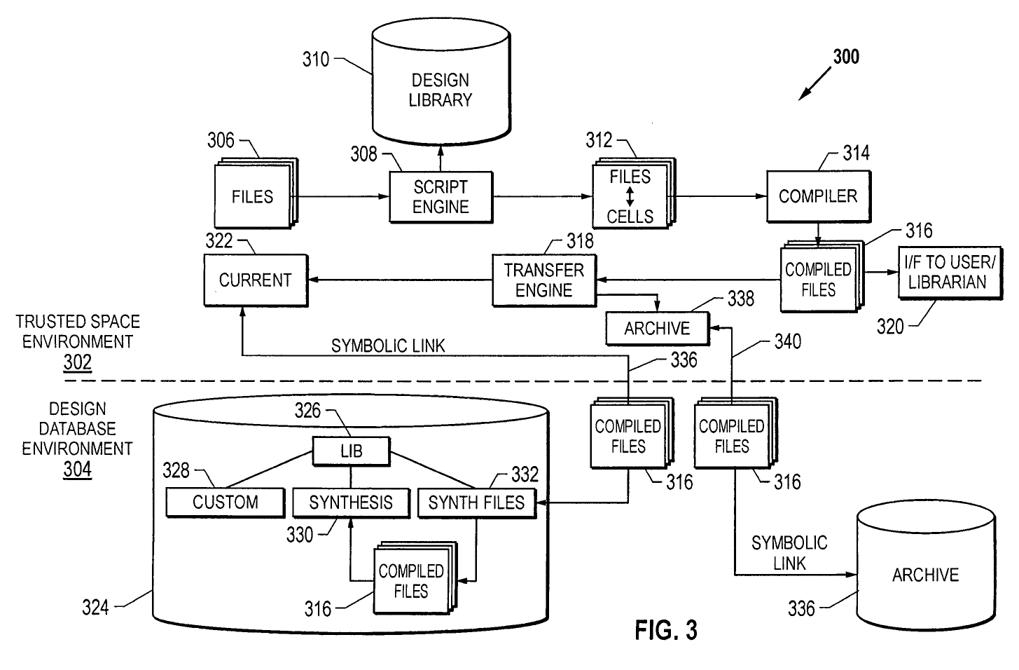

FIG. 3 depicts one embodiment of a system 300 spanning a trusted space environment 302 and a design database environment 304, which facilitates the building and transfer of update files 306 provided by a design user from the trusted space environment 302 to the design database environment 304. The trusted space environment 302 accommodates the building of the update files 306 such that in the event of an unsuccessful build, the design space environment is not corrupted. As illustrated, a script engine 308, i.e., a first engine, receives the update files 306 and associates the update files 306 with the appropriate design objects from a design library 310 in order to generate an uncompiled update files 312. The files 306 may be provided by a librarian or a user. For example, a librarian may provide the files to perform an update on the primary library that is in the unstable space. By way of another example, a user may provide the file to perform an update on a testing library such as library 114 of FIG. 1, for example. A compiler 314, i.e., a second engine, compiles the uncompiled update files 312 and generates compiled files 316, which are received by a transfer engine 318, i.e., a third engine. It should be appreciated that the compiled files 316 may be accessed by a design user as indicated by an interface 320. For example, even if the compiled files 316 are corrupted or errors exist, the design user may still wish to access the compiled files 316. Moreover, as another option, if the compiled files 316 are corrupted, the compiled files 316 may not be transferred to the design database environment 304. Further, if the trusted space environment 302 crashes due to corrupted compiled files 316, the design database environment 304, wherein many design users may be operating, is not affected.

The transfer engine 318 utilizes a current file structure 322 to transfer the compiled files 316 from the trusted space environment 302 to a library 324 in the design database environment 304. By only transferring compiled files 316 which are completely tested and built, it should be appreciated that the resources of the design database environment 304 are not unnecessarily expended or tied-up. Similar to the library 200 described in FIG. 2A, library 324 includes a hierarchical file structure including a lib structure 326 root node and a sub-hierarchical structure including a custom structure 328, a synthesis structure 330, and a synth files structure 332.

In one embodiment, the compiled files 316 are transferred from the trusted space environment 302 to the synth files structure 332 via symbolic link 334. The symbolic link 334, i.e., a “symlink” or “soft link,” is a link which refers to another file by its pathname. In contrast to a hard link, a symbolic link has no restrictions as to where it can point. Hence, the symbolic link can point to another file in another data structure residing in another system or design space. In the illustrated example, the current file structure refers to the synthesis file structure 332, which receives the compiled files 316 from the trusted space environment 302 and integrates the compiled files 316 into the synthesis file structure 330. After the update files are transferred and successfully installed in the target library 324, the transfer engine 318 may utilize an archive file structure 338 and a symbolic link 340 to transfer the compiled files 316 from the trusted space environment 302 to an archive data structure 336. It should be appreciated that although the archive data structure 336 is depicted in the design database environment 304, the archive data structure 336 may also be in an environment that is different from the environment of library 324.

Each of the script engine 308, compiler 314, and transfer engine 318 may comprise any combination of hardware, software, and firmware. Moreover, the script engine 308, compiler 314, and transfer engine 318 may be supported and/or embodied by the file structures discussed in association with FIG. 2B. For example, the script engine 308 may be supported by the script file structure 266 of FIG. 2B and the compiler 314 and transfer engine 318 may be supported by the build file structure 264 of FIG. 2B.

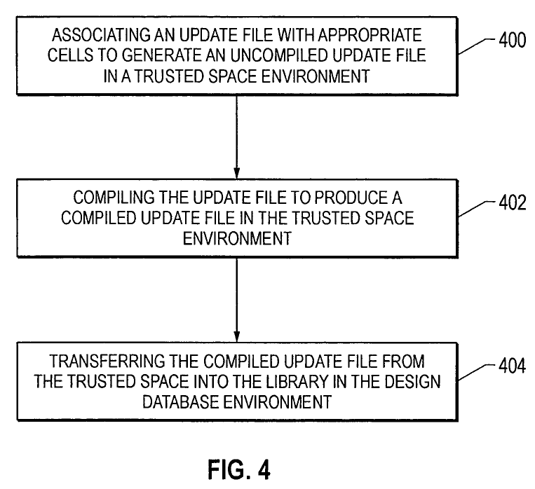

FIG. 4 depicts one embodiment of a computer-implemented methodology for updating a library in a design database environment. At block 400, an update file is associated with appropriate design objects, e.g., cells, to generate an uncompiled update file in a trusted space environment. The update file may be provided by any design user for any target library. At block 402, the update file is compiled to produce a compiled update file in the trusted space environment. At this time, testing by the design user of the compiled update file may occur to ensure the operability and functionality of the compiled file. At block 404, the compiled update file is transferred from the trusted space into the library in the design database environment. By loading only compiled update files into the library in the design database environment as described herein, downtime is minimized and system resources conserved.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

1. A system for updating a library in a design database environment operable to be accessed by at least one design user, comprising:
a first engine for associating an update file with appropriate design objects to generate an uncompiled update file in a trusted space environment;
a second engine associated with said trusted space environment for compiling said uncompiled update file into a compiled update file; and
a third engine for transferring said compiled update file from said trusted space environment into said library in said design database environment.

2. The system as recited in claim 1, wherein said design database environment is immune to corruption in an event of an unsuccessful compilation in said trusted space environment.

3. The system as recited in claim 1, wherein said update file includes files relating to a design element selected from the group consisting of gates, latches, passive elements, combinatorial elements.

4. The system as recited in claim 1, wherein said third engine effectuates the transfer of said compiled update file via a symbolic link between said trusted space environment and said design database environment.

5. The system as recited in claim 1, wherein said third engine is operable to transfer said compiled update file from said trusted space environment into an archive database.

6. The system as recited in claim 1, wherein said first engine, said second engine, and said third engine are integrated within a synthesis interface.

7. A computer-implemented method for updating a library in a design database environment operable to be accessed by at least one design user, comprising:
associating an update file with appropriate design objects to generate an uncompiled update file in a trusted space environment;
compiling said update file to produce a compiled update file in said trusted space environment; and
transferring said compiled update file from said trusted space environment into said library in said design database environment.

8. The computer-implemented method as recited in claim 7, further comprising isolating said trusted space environment from said design database environment.

9. The computer-implemented method as recited in claim 7, further comprising transferring said compiled update file from said trusted space environment to an archive database.

10. The computer-implemented method as recited in claim 7, further comprising building a symbolic link from said trusted space environment to said library in said design database environment.

11. The computer-implemented method as recited in claim 10, wherein the operation of transferring said compiled update file further comprises transferring said compiled update file from said trusted space environment into said library in said design database environment via said symbolic link.

12. The computer-implemented method as recited in claim 7, further comprising incorporating said compiled update file into a synthesis file structure within said design database environment.

13. A computer-readable medium operable with a computer platform for updating a library in a design database environment operable to be accessed by at least one design user, the medium having stored thereon:
instructions for associating an update file with appropriate design objects to generate an uncompiled update file in a trusted space environment;
instructions for compiling said update file to produce a compiled update file in said trusted space environment; and
instructions for transferring said compiled update file from said trusted space environment into said library in said design database environment.

14. The computer-readable medium as recited in claim 13, further comprising instructions for isolating said trusted space environment from said design database environment.

15. The computer-readable medium as recited in claim 13, further comprising instructions for transferring said compiled update file from said trusted space environment to an archive database.

16. The computer-readable medium as recited in claim 13, further comprising instructions for building a symbolic link from said trusted space environment to said library in said design database environment.

17. The computer-readable medium as recited in claim 16, wherein said instructions for transferring said compiled update file further comprise instructions for transferring said compiled update file from said trusted space environment into said library in said design database environment via said symbolic link.

18. The computer-readable medium as recited in claim 13, further comprising instructions for incorporating said compiled update file into a synthesis file structure within said design database environment.

19. A computer system, comprising:
a database design environment having a design library;
a user interface operable to generate updates for said library; and
a synthesis interface for transferring said updates from said user interface to said design library by establishing a trusted space environment that provides for building of said updates prior to the transfer of said updates.

20. The computer system as recited in claim 19, wherein said design library is a library selected from the group consisting of a primary library, an archive library, and a testing library.

21. The computer system as recited in claim 19, wherein said design library comprises a standard cell library.

22. The computer system as recited in claim 19, further includes a structure for compiling said updates.

23. The computer system as recited in claim 19, wherein said synthesis interface is operable to transfer said updates from said trusted space environment to said design library via a symbolic link.

24. The computer system as recited in claim 19, wherein said synthesis interface is operable to transfer said updates from said trusted space environment to an archive database.

25. A library infrastructure system for maintaining a database in a design environment, comprising:
a first design library in a stable space operable to be accessed by at least one user;
a second design library in an unstable space operable to be accessed by at least one librarian; and
an interface for facilitating file updates of said first and second design libraries, said interface being operable to build said file updates in a trusted space and appropriately transfer said file updates to said first and second design libraries.

26. The library infrastructure system as recited in claim 25, wherein said first and second design libraries are redefined such that said first design library resides in said unstable space operable to be accessed by at least one librarian and said second design library resides in said stable space operable to be accessed by at least one user.

27. The library infrastructure system as recited in claim 25, wherein permissions associated with said first and second design libraries are changed such that said first design library resides in said unstable space operable to be accessed by at least one librarian and said second design library resides in said stable space operable to be accessed by at least one user.

28. The library infrastructure system as recited in claim 25, further comprising a third design library operable to be accessed by said at least one user for testing purposes.

29. The library infrastructure system as recited in claim 25, further comprising a third design library operable to store an archive of the contents of said first design library.

30. The library infrastructure system as recited in claim 25, wherein said second design library is provided to be a mirror copy of said first design library.

31. A computer-implemented system for updating a library in a design database environment operable to be accessed by at least one design user, comprising:
means for associating an update file with appropriate design objects to generate an uncompiled update file in a trusted space environment;
means for compiling said uncompiled update file into a compiled update file; and
means for transferring said compiled update file from said trusted space environment into said library in said design database environment.

32. The computer-implemented system as recited in claim 31, wherein said design database environment is immune to corruption in an event of an unsuccessful compilation in said trusted space environment.

33. The computer-implemented system as recited in claim 31, wherein said update file includes files relating to a design element selected from the group consisting of gates, latches, passive elements, combinatorial elements.

34. The computer-implemented system as recited in claim 31, wherein said means for transferring said compiled update file effectuates the transfer of said compiled update file via a symbolic link between said trusted space environment and said design database environment.

35. The computer-implemented system as recited in claim 31, wherein said means for transferring said compiled update file is operable to transfer said compiled update file from said trusted space environment into an archive database.
